(19) United States
(12) Patent Application Publication
(10) Pub. No.: US 2014/0297331 A1
(43) Pub. Date: Oct. 2, 2014

(54) SYSTEMS AND METHODS FOR ORGANIZING, STORING, COMMUNICATING, AND VERIFYING INFORMATION THROUGHOUT THE PROCESS OF PROVIDING HEALTHCARE SERVICES

(71) Applicant: Single Point of Truth Medical Software, LLC, Chicago, IL (US)

(72) Inventors: Richard M. Vazquez, Chicago, IL (US); Daniel Parsons, Chicago, IL (US); Michael Kelly, Chicago, IL (US)

(21) Appl. No.: 14/299,934

(22) Filed: Jun. 9, 2014

Related U.S. Application Data
(63) Continuation of application No. PCT/US2013/044185, filed on Jun. 4, 2013.
(60) Provisional application No. 61/759,359, filed on Jan. 31, 2013.
(60) Provisional application No. 61/655,467, filed on Jun. 4, 2012.

(51) Int. Cl. G06Q 50/24; G06F 19/00

(52) U.S. Cl. CPC G06Q 50/24; G06F 19/322
USPC 705/3

(57) ABSTRACT

The systems and methods of the present disclosure acquire patient information and execute a time-out checklist for verifying information for a procedure to be performed by a healthcare provider. The patient information is acquired by entering patient information in fields of a checklist screen. The acquired patient information is displayed to the patient in a read-only patient data verification screen that includes a verification button that the patient can select to verify whether the displayed patient information is correct. After the patient information is verified by the patient, the patient information is displayed in the checklist screen having verification buttons corresponding to the patient data and items to be verified for the procedure. The verification buttons are enabled after an image of the site marking is captured. The checklist application also acquires audio and/or video during execution of the time-out checklist.

### BACKGROUND

1. Technical Field

The present disclosure relates to the process of providing healthcare services and, more particularly, to systems and methods for organizing, storing, communicating, and verifying information throughout the process of providing healthcare services.

2. Background of Related Art

Wrong-site surgery and other preventable surgical errors are typically caused by scheduling and preoperative/holding process breakdowns, ineffective communication or distractions in the operating room, documentation or verification issues, incorrect or inadequate information, and/or breakdowns during hand-offs. Communication and information breakdowns also contribute to errors in other patient care processes other than outpatient surgery, e.g., inpatient procedures, dental procedures, veterinary procedures, and other patient care or healthcare-related procedures.

In an effort to promote surgical safety and combat some of the causes of wrong-site surgery, the World Health Organization (WHO) has created a Surgical Safety Checklist designed to standardize safety procedures to be followed during sign-in, time-out, and sign-out. The Joint Commission on Accreditation of Healthcare Organizations (JCAHO) and other professional societies have adopted the Surgical Safety Checklist and have encouraged local customization of the Surgical Safety Checklist. On the one hand, these checklists are overly broad, generic checklists, usually printed on a laminated card, that by their existing format are not patient or procedure specific and are designed to be used for all procedures and all patients. To complete these checklists, a nurse or other healthcare provider must gather information from a variety of sources including the operating room schedule, the operative consent, the patient's chart, etc. On the other hand, these checklists are overly narrow in that they are only applicable to the “pauses,” e.g., sign-in, time-out, and sign-out, associated with a surgical procedure. Also, during the process of executing a checklist, there is often a lack of cooperation by all of the participants in the process.

Patients often participate in the time-out checklist process by certifying that the patient information gathered by the healthcare provider is correct. However, when patients participate in this process, their level of consciousness is often compromised by medication, anesthesia, the disease process, etc., and no surrogate may be available to participate in the time-out checklist process.

### SUMMARY

The systems and methods in accordance with aspects of the present disclosure enable patients to certify the correctness of information gathered by the healthcare provider before the patients' level of consciousness is compromised. The systems and methods of the present disclosure also facilitate cooperation among participants in the checklist execution process. The systems and methods of the present disclosure also reduce errors that arise when patient information is passed among healthcare providers that are involved with the scheduling, preparation, and execution of a procedure performed by the healthcare providers.

The systems and methods provided in accordance with aspects of the present disclosure enable the organization, storage, communication, and/or verification of information between a healthcare provider, a patient (including anyone authorized, obligated, or appointed to act on the patient's behalf, e.g., a guardian (parental or legal), healthcare proxy, designated agent, or other representative), and other relevant parties (using various different, remotely and/or locally located devices) throughout the entire process of providing healthcare services, e.g., from a patient-surgeon meeting in the surgeon's office through pre-surgical and post-surgical checkups, and to communicate and integrate such information with other applications, programs, servers, databases, and systems, e.g., electronic medical record (EMR) and/or healthcare scheduling systems.

Although the present disclosure is described for exemplary purposes with respect to the surgical process, it is contemplated and within the scope of the present disclosure that the aspects and features described herein be equally applicable for use in any healthcare services related procedure, process, or setting. It is therefore understood that use of the terms surgeon, surgical team members, etc., are merely examples of “healthcare providers,” as is anyone else involved in the rendering of healthcare services such as, for example, physicians, dentists, veterinarians, clinicians, practitioners, nurses, technicians, staff members, etc. Thus, the checklist application according to the present disclosure applies to any procedure that is performed within any field in the healthcare industry. For example, the checklist application applies to procedures performed within any medical specialty such as anesthesia, radiology, cardiology, obstetrics, endocrinology, orthopedics, etc.

In aspects, the applications, systems, and methods provide for customizable checklists, e.g., surgical checklists tailored to a particular patient and/or the surgical procedure to be performed. Information required to complete the checklist may be initially input by a patient, surgeon, surgical team member, and/or staff member, e.g., at a patient-surgeon initial meeting regardless of location. This information may be accessible to the patient for verification, correction, and/or certification, e.g., at the patient's home computer, smartphone, etc. The information may be used to pre-populate the checklist to be used by the surgeon, surgical team, and/or staff members before, during, and after the surgical procedure.

The pre-populated, customized checklist is made available to the surgeon, surgical team, patient, and/or staff members, e.g., on a computer, tablet device, or other suitable electronic device at the operating facility, for completion of the checklist, communication of the checklist or information associated therewith, and/or storage of the checklist or information associated therewith.

In aspects, the applications, systems, and methods provide for integration of the checklists and associated information with electronic scheduling systems, electronic medical record systems, patient portals, healthcare facility's systems, and other electronic healthcare systems, e.g., eClinicalWorks. For example, the applications, systems, and methods may directly secure information from an EMR database to the checklist application database.

In aspects, the applications, systems, and methods synchronize multiple devices, e.g., computers, tablets, handheld devices, etc., with one another, servers, databases, and/or other systems across one or more networks to facilitate pre-populating information fields, verifying information, communicating information, and/or storing information. The checklist application may be configured by the user to sync the checklist data residing in memory of the user's electronic device with local and/or remote secure servers via a wired and/or wireless connection.

In aspects, the applications, systems, and methods track progress of the checklist, e.g., via providing a percentage complete display, and/or inhibit progression through the checklist until some or all previous items are complete.

In aspects, the applications, systems, and methods timestamp, record user-information, and/or track some or all data entries, completion of checklist items, modification of information, or various other functions.

In aspects, the applications, systems, and methods securely backup information at predetermined times or time intervals, after particular checklist items, portions of the checklist, or the entire checklist are complete, and/or via user-directed or on-demand backup.

In aspects, the applications, systems, and methods provide screenshot capability allowing the capture of static images, or photos, of the checklist as viewed by the user at predetermined times or time intervals, after particular checklist items, portions of the checklist, or the entire checklist are complete, and/or via user-selected screenshot capture. In such aspects, the screenshot images may be saved locally on the user's device, emailed, printed, uploaded and stored on a server, and/or communicated to other devices, databases, or systems, e.g., uploaded to an electronic medical record database storing the patient's electronic medical records. Screenshot capture, email, upload, etc. of a checklist may be inhibited prior to completion of the entire checklist, may be permitted at prescribed points, or may be freely permitted.

In aspects, the applications, systems, and methods integrate audio and/or video recording capability for audibly/visually verifying or completing some or all checklist items, storing general audio and/or video recordings, associating particular audio and/or video recordings with particular checklist items or information, and/or emailing, uploading, storing, or communicating audio and/or video recordings to databases, servers, systems, or other devices.

In aspects, the applications, systems, and methods may provide an interface that prompts the user to confirm their identity at the completion of a checklist item or group of items, e.g., via integration with voice/video capture, requiring the user to log in, etc.

In aspects, the applications, systems, and methods provide alerts based on particular information provided; whether or not information has been verified by the patient or other user; the presence of conflicting/inconsistent information; the presence of incomplete information; the user, location, and/or date and time when information has been entered, deleted, or modified; the checklist items that have been completed or not completed, etc. Both active and passive alerts are contemplated, depending on the particular alert or other factors. For example, the user may be warned or alerted as to inconsistent information while still being permitted to continue, but may be inhibited from continuing if a checklist item has not been completed.

In aspects, the applications, systems, and methods provide users with different levels of accessibility and permissions to maintain the integrity of the healthcare information and to prevent potential errors in providing healthcare services. For example, some users, e.g., the surgeon, may have full access and permission to view, input, modify, and/or delete information and to complete some or all of the checklist items. Other users, e.g., the patient, may have read-only access, or limited access allowing the user to only verify, certify, comment, and/or provisionally modify information. Still other users, e.g., the surgical team or staff members, may have limited access with respect to inputting, modifying, and deleting information, and/or completing checklist items. In one configuration, the checklist may be locked to certain users, e.g., presented in read-only form, or may be capable of being unlocked based on the satisfaction of one or more conditions, e.g., on the condition that any or all modifications be time stamped and authenticated, or that users be notified if and when information in the checklist has been updated or changed.

Devices suitable for use with the presently disclosed applications, systems, and methods include, but are not limited to desktop computers, laptop computers, tablet computers, e.g., iPads, handheld electronic devices, e.g., smart phones, and the like.

In aspects, the present disclosure features a method for verifying information for a procedure performed by a healthcare provider. The method includes acquiring patient data including patient name data, patient medical data, procedure data, patient identification data, and acquiring patient verification data verifying the correctness of the patient data. The method also includes displaying, in a graphical user interface, the patient data and at least a first verification button corresponding to the patient data; and displaying, in the graphical user interface, procedure checklist items and at least a second verification button corresponding to procedure checklist items to be verified before execution of the procedure and a certification field. The method further includes acquiring audio and/or video data until the at least the first verification button and the at least the second verification button have been selected and certification data has been entered into the certification field.

The patient data may be acquired from a healthcare provider server and populating patient data fields in the graphical user interface corresponding to the patient identification data, the patient medical data, and the procedure data. The patient identification data may be biometric data, a unique identifier, and a photographic image.

In aspects, the method may include determining whether the patient data has been verified by the patient based on the patient verification data, and displaying the patient data and at least one verification button corresponding to the patient data if it is determined that the patient data has been verified by the patient. In aspects, the method may include transmitting the patient data to another computing device which displays the patient data and generates the patient verification data, and receiving the patient verification data from another computing device.

In aspects, the method includes starting a timer when the patient verification data is generated, determining whether the time of the timer is greater than a predetermined time value, and deleting the patient verification data if it is determined that the time of the timer is greater than the predetermined time value.

In aspects, the steps of acquiring patient data and patient verification data are performed in a data acquisition mode, and the steps of displaying in the graphical user interface and capturing audio and/or video data are performed in an execution mode. The data acquisition mode and the execution mode may be enabled based on the timing provided by a scheduling application.

In aspects, the method includes displaying, in a first screen, data fields corresponding to the patient name data, the patient medical data, the procedure data, and the patient identification data. The method also includes storing data entered into the data fields of the first screen in a database, displaying, in a second screen, which is read-only, the patient name data, the patient medical data, the procedure data, the patient identification data, and a patient verification button, which, when selected by the patient, generates the patient verification data. The method also includes storing the patient verification data in the database.

In aspects, the verification buttons are not enabled until an image of a procedure site or a consent form is captured. The method may further include displaying a message prompting the user to capture an image of the procedure site to enable the verification buttons.

In aspects, the method further includes capturing an image of the graphical user interface when the certification data has been entered into the certification field, and saving the captured image to a local or remote database or transmitting the captured image to another computing device.

In aspects, the method further includes displaying an edit button enabling a user to edit the patient data and displaying a time stamp near the patient data that is edited by the user.

In aspects, the method further includes displaying a progress bar that increases in size as verification buttons are selected and certification information is entered into the certification field.

In aspects, the items that must be verified before carrying out the procedure are selected from the group consisting of whether the patient position is correct, whether the side/site marking is visible, whether a medication has been administered to the patient, whether lab tests have been ordered, whether instruments for the procedure are present, whether implants are present, whether X-rays are present, or any combination of these items.

In aspects, the present disclosure features a method of verifying information for a clinical procedure. The method includes displaying, via a graphical user interface, patient data fields including a patient name data field, a patient identification data field, a patient medical data field, and a clinical procedure data field. The method further includes storing patient data entered into the patient data fields in memory, and displaying, via the graphical user interface, a verification button corresponding to each of the patient data fields, procedure checklist items to be verified before execution of the clinical procedure, and at least one verification button corresponding to each of the procedure checklist items. The method further includes prompting a user to capture an image of an operative site or another image related to the clinical procedure, determining whether an image of the operative site has been captured, and enabling use of the verification buttons if it is determined that an image of the operative site has been captured. The method further includes determining whether a verification button for each of the patient data fields and the procedure checklist items has been selected and signature data has been entered into a signature field, and capturing an image of the graphical user interface if it is determined that a verification button for each of the patient data fields and the procedure checklist items has been selected and signature data has been entered into a signature field.

In aspects, acquiring an image of the patient includes displaying a button, which, when depressed, enables the user to search for and select an image stored in a local or remote database or to capture an image of the patient using an imaging device in communication with the graphical user interface. In aspects, the verification buttons are maintained in a non-functional state until an image of the operative site is captured.

In aspects, the present disclosure also features a system for verifying patient data for a clinical procedure. The system includes a healthcare provider server and a healthcare provider device in communication with the healthcare provider server. The healthcare provider server is configured to store patient data and to transmit the patient data to a patient device for verification by a patient. The healthcare provider device includes a processor and a memory storing instructions that, when executed by the processor, causes the healthcare provider device to display a patient data acquisition screen having patient data fields in which to input patient data and transmit the patient data entered into the patient data fields of the patient data acquisition screen to the healthcare provider server. The instructions further cause the healthcare provider device to receive patient verification data from the patient device and to display a checklist execution screen including patient data fields populated with the patient data, a verification button corresponding to each of the patient data fields, descriptions of items to be verified for the clinical procedure, at least one verification button corresponding to each of the items to be verified for the clinical procedure, and a certification button for approving a completed checklist. The instructions further cause the healthcare provider device to capture an image of a procedure site or another image related to the clinical procedure and capture an image of the checklist execution screen when the certification button is selected.

In aspects, the checklist execution screen may be display if it is determined, based on the patient verification data, that the patient approves of the patient data entered into the patient data fields of the patient data acquisition screen. The patient data may include patient name data, patient medical data, clinical procedure data, and patient identification data.

In aspects, the instructions may further cause the healthcare provider device to acquire audio and/or video data while the checklist execution screen is being displayed.

In aspects, the verification buttons and the certification button are not enabled for use until after an image of the procedure site or other image related to the clinical procedure is captured.

### BRIEF DESCRIPTION OF THE DRAWINGS

Various aspects of the present disclosure are described herein below with reference to the drawings, wherein:

FIG. 1 is a schematic diagram of a checklist system according to aspects of the present disclosure;

FIG. 2 is a schematic diagram of a checklist system according to further aspects of the present disclosure;

FIG. 3 is a schematic diagram of a checklist system according to still further aspects of the present disclosure;

FIG. 4 is a schematic diagram of a checklist system according to still further aspects of the present disclosure;

FIG. 5 shows a healthcare provider (HCP) device displaying a checklist screen of a checklist software application according to aspects of the present disclosure;

FIG. 6 shows an HCP device displaying a patient data entry screen of a checklist software application according to other aspects of the present disclosure;

FIG. 7 shows an HCP device displaying an initial checklist screen of the checklist software application according to the other aspects of the present disclosure;

FIG. 8 shows an HCP device displaying a site marking image capturing screen of the checklist software application according to the other aspects of the present disclosure;

FIG. 9 shows an HCP device displaying a site marking image reviewing screen of the checklist software application according to the other aspects of the present disclosure;

FIG. 10 shows an HCP device displaying a building time-out screen of the checklist software application according to the other aspects of the present disclosure;

FIG. 11 shows an HCP device displaying a checklist screen of the checklist software application according to the other aspects of the present disclosure;

FIG. 12 is a flow diagram of a method for verifying patient data for a clinical procedure according to aspects of the present disclosure;

FIG. 13 shows a patient device displaying a patient data verification screen according to an aspect of the present disclosure; and

FIG. 14 is a flow diagram of a method for verifying patient data for a clinical procedure according to other aspects of the present disclosure.

### DETAILED DESCRIPTION

The present disclosure describes applications, systems, and methods that enable the organization, storage, communication, and/or verification of information related to a surgical procedure (or any healthcare service, process, or procedure). This information may be shared among a healthcare provider, e.g., surgeon, a patient, and other relevant parties. The applications, systems, and methods may be incorporated into various different devices for use at various different locations, e.g., in the surgeon's office, patient's home, operating room, etc., and may be integrated across one or more networks with various servers, databases, systems, and devices. The applications, systems, and methods according to the present disclosure allow the surgeon, the surgical team members, and/or other relevant staff members to interact with the information related to the surgical procedure to reduce the risk of surgical errors. Accordingly, although specific implementations of the present disclosure are described below, it is envisioned that the present disclosure be implemented in any suitable fashion and that any of the features described herein be combined with any or all of the other features described herein.

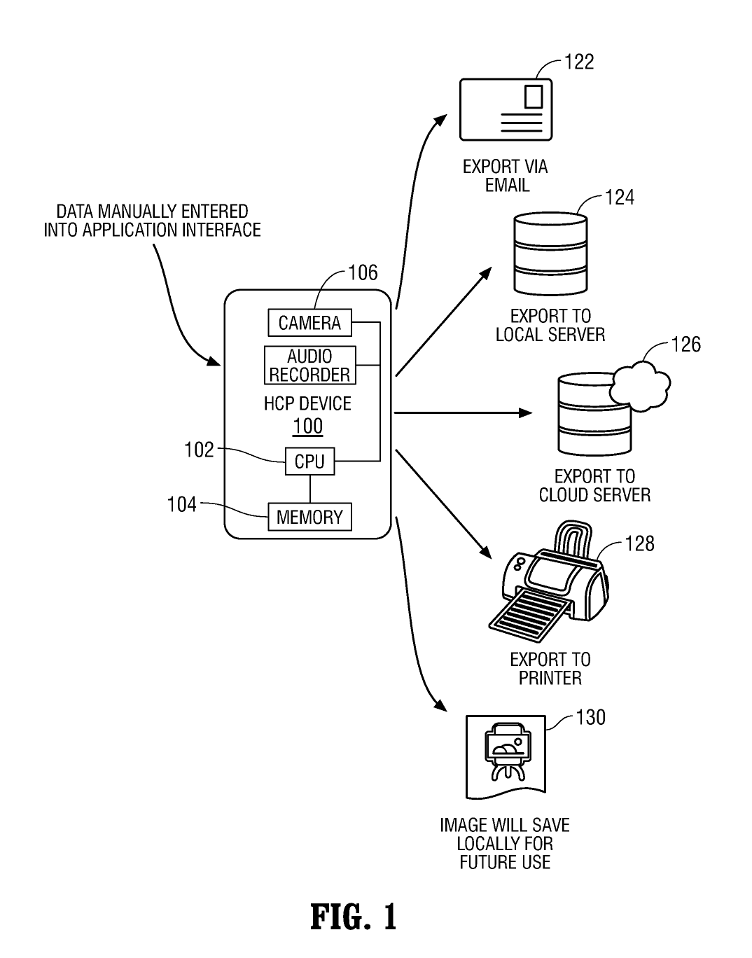

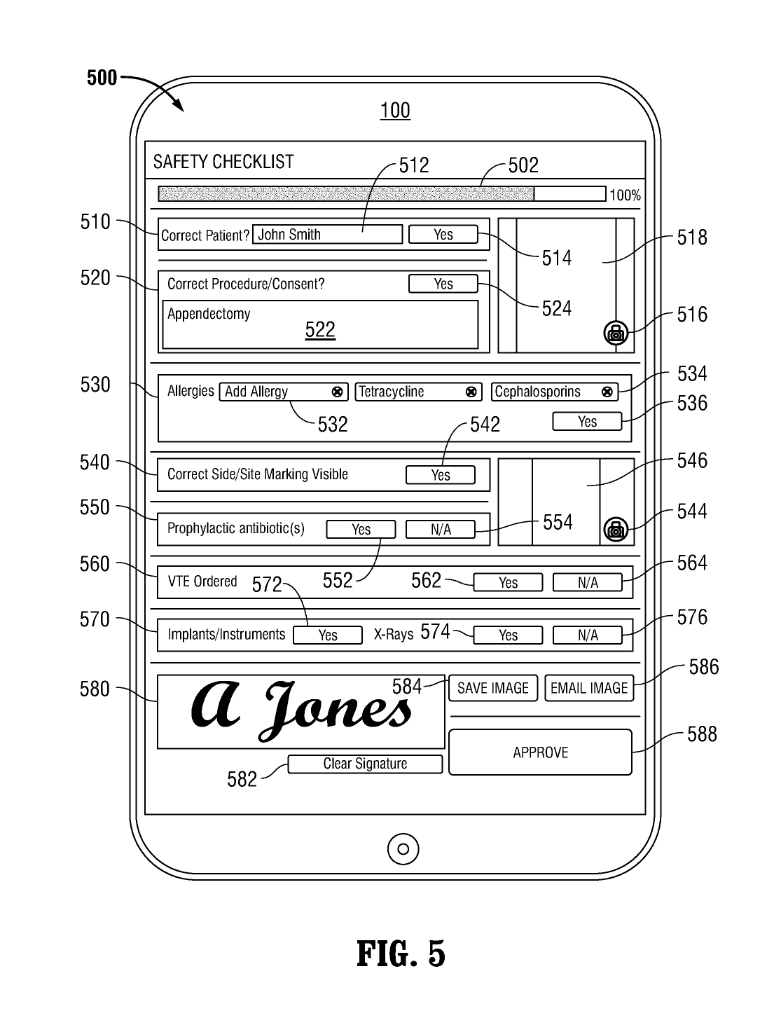

Turning now to FIGS. 1-4, the checklist application described below and shown in FIGS. 5-11 may be integrated across one or more networks with various databases, servers, systems, application, programs, and devices to facilitate the organization, storage, communication, and verification of information associated with the checklist and a procedure to be performed by a healthcare provider in general. Although various different configurations are described below, these configurations are exemplary only, as it is envisioned that the present disclosure be configured to integrate with any suitable components.

With reference to FIG. 1, a first configuration is shown for inputting information into the checklist application via a healthcare provider's device 100 (e.g., a tablet computer, handheld device, etc. having central processing unit 102, a memory 104, and a camera 106) in the surgeon's office, at the patient's bedside, etc. and communicating such information as required. This information may be, for example, information obtained by the surgeon, surgical team member, or staff member, during a patient meeting in the surgeon's office that may then be used to populate and customize the checklist, or may be information input during actual completion of the checklist, e.g., at patient sign-in, time-out, or patient sign-out.

With respect to the initial gathering of information, this information may be input into the checklist application via the healthcare provider's device, e.g., the surgeon's device, in the presence of the patient, e.g., at the patient's bedside, thus providing on-site verification. Alternatively, this information may be entered at a later time by the surgeon, a surgical team member, or a staff member. As will be described below, opportunity will be provided for the patient to verify this information, which is particularly useful in instances where on-site verification is not obtained or for double-check verification.

The information input into the checklist application may be sent or exported via email 122 to the surgeon, patient, referring physician, or other necessary party for verification, comment, record keeping, etc. The information may be additionally or alternatively uploaded or exported to a local server 124 for secure storage, and/or a cloud server 126 for backup storage. The information may further be uploaded to other systems, applications, programs, servers, databases, and/or devices to permit remote verification, completion of information, pre-populating of information fields associated with these other components, and updating of such components. The information input into the checklist may be sent by the user to other systems or devices in static form, e.g., a screenshot, in dynamic form, e.g., a form with editable fields, or a combination thereof. The information input into the checklist may be sent to or exported to a printer 128 so that the surgeon, patient, referring physician, or other necessary party can verify the information, provide comments on the information, perform record keeping functions, etc.

With respect to the completion of the checklist or portion thereof on the healthcare provider's device, the checklist or portion thereof may be completed while completion status updates and/or associated information are sent via email 122 and/or are printed 128. Completion status updates and/or associated information may additionally or alternatively be uploaded to a local server 124 for secure storage and/or a cloud server 126 for backup storage. This information may also be uploaded for updating other databases, systems, applications, programs, and/or devices with the most current information. Screenshot images of the checklist, images of the patient and/or surgical site marking captured by the camera 106 of the healthcare provider (HCP) device 100, audio, video, and/or text files associated with the checklist may likewise be saved locally to the healthcare provider device, e.g., an image may be saved locally for future use 130, emailed 122, printed 128, uploaded to a local server 124, uploaded to a cloud server 126, and/or uploaded to other components, e.g., databases, systems, applications, programs, and/or devices.

Further, the display as viewed by the user inputting information and/or completing the checklist may be mirrored on another system or device for monitoring, informing, and updating other relevant parties as to the status of the surgical process. Thus, for example, surgical team members associated with different aspects of the surgical process and with access to a suitable device may be kept apprised of important information, status updates, changes, etc. of the procedure as it is entered by the surgeon, patient, other surgical team member, or staff member at a remote location on a different device. The display may also be mirrored on a larger display or monitor to facilitate communication and verification of information or checklist items by all relevant parties in the same location, e.g., to display the checklist and associated information for viewing by all surgeons and surgical team members in the operating room during a live time-out process.

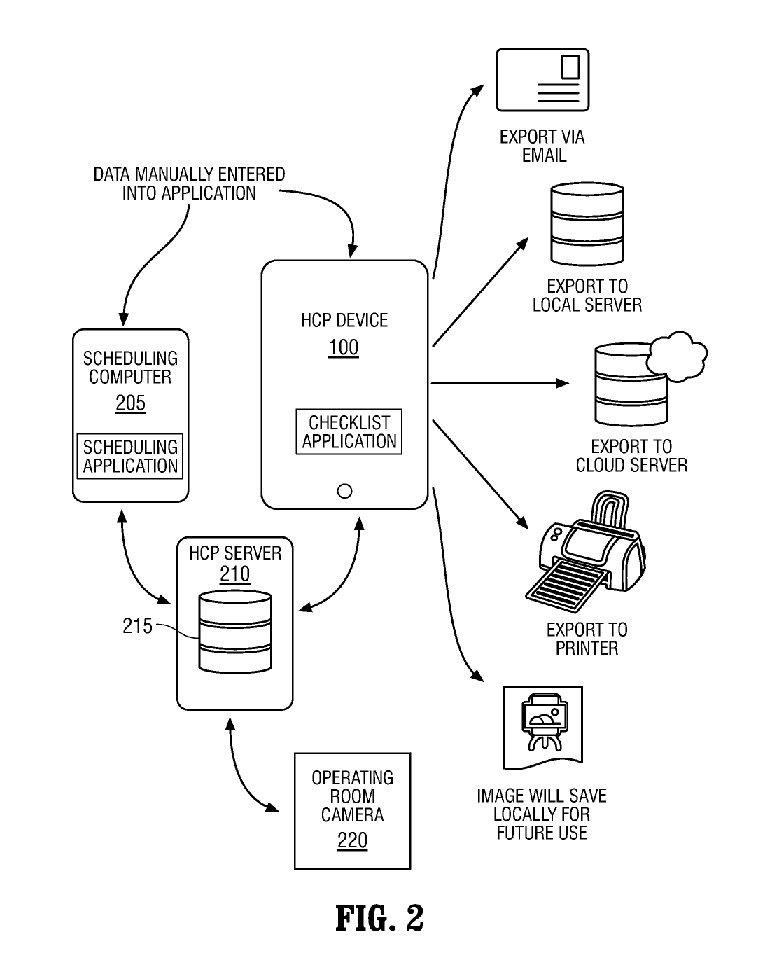

Referring to FIG. 2, a second system configuration is illustrated that includes the features described above with respect to FIG. 1, and further provides for the integration of the checklist application with a scheduling application, program, or system running on the scheduling computer 205 that is located at a healthcare provider's office. In this configuration, the healthcare provider's device 100 including the checklist application communicates with a healthcare provider server 210 that includes a database 215 for storing, sending, and receiving information, such as any of the information described above.

The system configuration of FIG. 2 also includes a camera 220 which is disposed within an operating room and positioned to capture audio and/or video of the execution of a checklist generated by the checklist application running on the HCP device 100. The camera 220 provides audio and/or video data to the HCP server 210 via communications established between the camera 220 and the HCP server 210. Thus, in the system configuration of FIG. 2, the HCP device 100 can access an audio and/or video recording of healthcare providers executing a time-out checklist of the checklist application and associate the audio and/or video recording with the time-out checklist. This feature adds another level of safety to the time-out procedure.

The HCP server 210 likewise communicates with the scheduling computer 205 running a scheduling application such that information input into the checklist application or scheduling application may be used to pre-populate fields in the other of the scheduling application and checklist application. For example, information regarding the facility where the surgery is to be performed, the time allotment, equipment, team, and staff necessary for the surgery, and/or the patient, surgeon, facility, equipment, team, and staff availability may be communicated between the HCP device 100 and the scheduling computer 205 to facilitate scheduling of the appropriate dates, times, locations, equipment, and personnel for the surgery as well as completion of the checklist.

Particular scheduling information regarding the surgeon, facility, equipment, team, and staff may also be communicated to the checklist application for customizing the checklist in accordance therewith. Likewise, particular information about the patient, surgery to be performed, or other information associated with the checklist may be sent to the scheduling application to allow for customized scheduling in the event atypical requirements with regard to the surgeon, surgical team, staff, facility, equipment, and/or time are necessary. Completion of specific checklist items or failure to do so may also be communicated to the scheduling computer 205 for updating the status of any such scheduled items accordingly.

As mentioned above, the healthcare provider's device may be used to email or print information, or to upload information to a printer 128, local server 124, cloud server 126, or may locally store information on the device itself, e.g., 130. Such features thus allow interaction and integration of these components with the scheduling application and database.

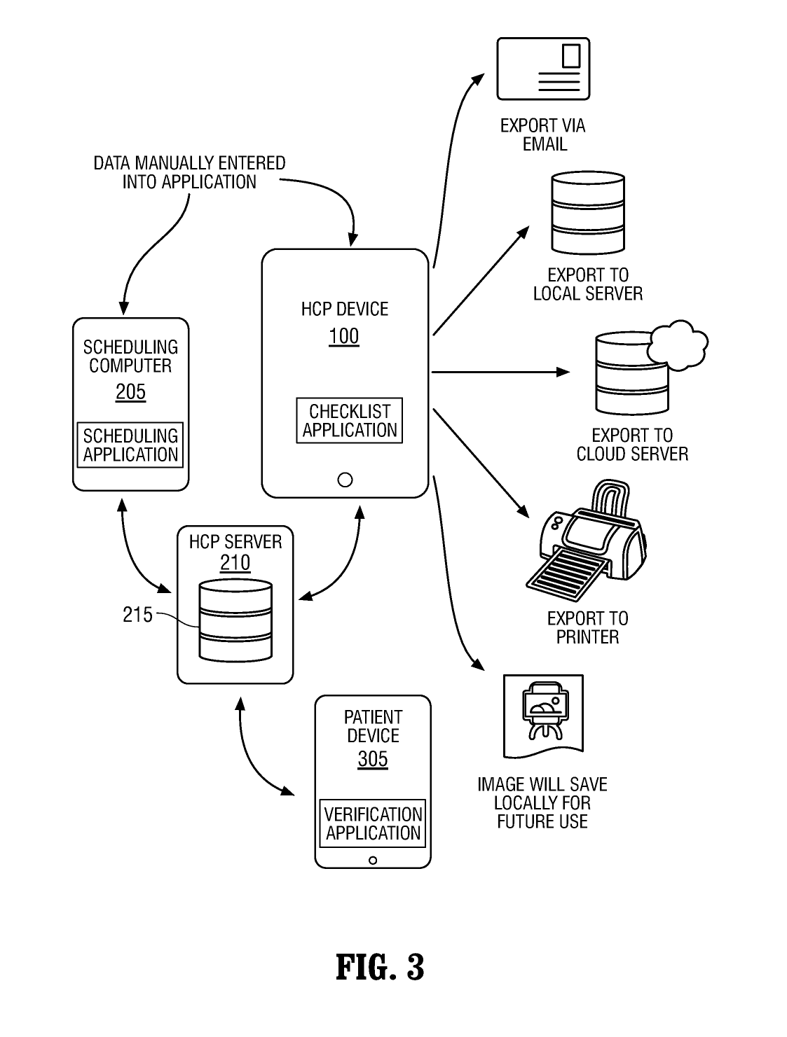

With reference to FIG. 3, the patient may access some or all of the information provided via the checklist application and scheduling application by communicating with the HCP server 210 using patient device 305, such as a computer, tablet computer, handheld device, or other suitable electronic device. That is, the patient may view, verify, and/or not verify information associated with the checklist application (via the database 215 of the HCP server 210), and/or confirm appointments and scheduling dates, etc., with the scheduling application (via the checklist application and the database 215 of the HCP server 210).

The patient may access some or all of the checklist information through a separate patient checklist application. In some embodiments, the patient may have read-only access to the checklist prior to the live time-out to ensure the integrity of the checklist information. The patient checklist application may allow the patient to comment on the correctness of the checklist information or to create and securely send a message to the healthcare provider to make changes or additions to the checklist information.

Similarly as described above, the healthcare provider, using the checklist application, may email 122, print 124, upload to a local server 124, cloud server 126, or locally store or otherwise communicate information received from the patient's device through the HCP server 210. The checklist application may also allow a user to input and view other data that is not required by the checklist such as a patient's pre-procedure height, weight, etc. This other data may be attached to or otherwise incorporated into the checklist when an image of the checklist is captured and stored and/or sent to another device.

In particular, patient participation in completing the checklist allows the patient to verify, confirm, modify, and/or comment on information associated with the checklist at various points during the surgical process, not just immediately prior to the actual surgery. A healthcare provider may complete the checklist on the healthcare provider's device in presence of the patient and allow the patient to review and sign off on the existing content of the checklist. Other non-vital data may also be presented to the patient for education, informational, or other purposes. On the other end, the surgeon, surgical team, and staff may be alerted, e.g., via one or more alerts displayed via the checklist application (as described above), as to whether the patient has confirmed information, viewed information, entered inconsistent information, etc.

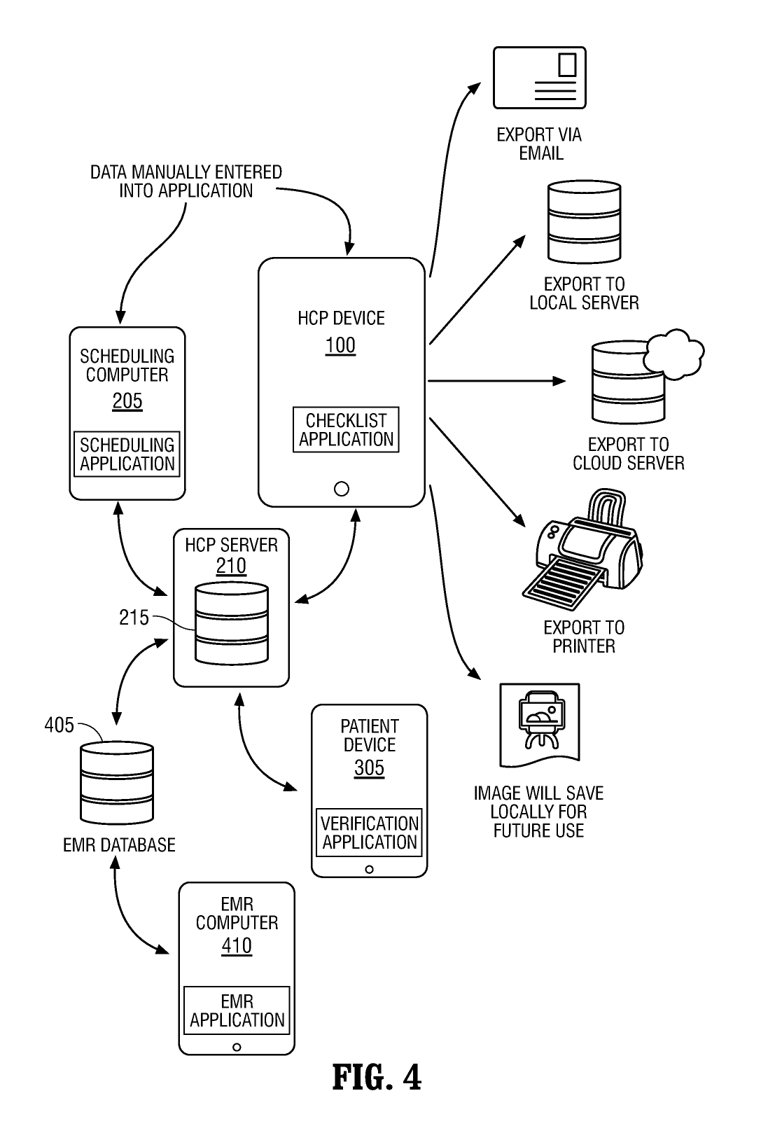

FIG. 4 illustrates another configuration including all of the features described above and further integrating an electronic medical records database 405 and associated electronic medical records application, program, or system running on a computer, tablet, handheld device, or other suitable electronic device 410. Integration of the checklist application with the electronic medical records database 405 allows for verification of information and ensuring consistency in information input into the checklist application, incorporation of additional information from the electronic medical records database 405 into the checklist application, and storing of screenshots of the checklists, patient verification information, audio, text, or video files, or other information obtained via the checklist application or other integrated applications, programs, and systems, within the patient's electronic medical records.

Turning now to FIGS. 5-14, in conjunction with FIGS. 1-4, a checklist application provided in accordance with the present disclosure is shown displayed on a user-interface 500 of the HCP device 100, which is a tablet computer or any other suitable electronic device. The checklist application is customizable such that the checklist may be tailored to a particular patient; particular protocols of the surgeon, surgical team, and/or surgical facility; the surgical procedure to be performed; and/or other events associated with providing healthcare services. Information required to complete the checklist may be input into the application by a patient, surgeon, surgical team member, and/or staff member. A healthcare provider may enter patient data in real time just prior to providing healthcare services, e.g., just prior to performing a surgical procedure.

Previously entered information from various sources (both internal and external to the device and/or application) may be used to pre-populate the checklist. For example, previous entry of the patient's name, procedure to be performed, allergies, etc., which may be stored in a remote database, are incorporated into and pre-populate the checklist, thus allowing the user to efficiently complete the corresponding checklist items. For example, patient information in an electronic medical record stored in a database may be used to pre-populate the checklist. Likewise, information input into the checklist application may be used to pre-populate other information fields associated with other systems, databases, programs, and applications.

The user-interface displays the name of the particular checklist used, the particular portion of the checklist currently viewed, and/or any other desired identifying information. In addition to this identifying information, a percentage completion bar 502 of the checklist screen 500 of FIG. 5 is provided, indicating both graphically and numerically, the current completion percentage of the checklist or particular portion thereof. As an alternative to or in conjunction with the percentage completion bar 502, any other suitable graphical indication of the progress of the checklist may be utilized. For example, the progress of the checklist may be graphically shown using a stoplight or the entire screen, background, or portion thereof, could change colors, etc.

The user-interface further may display the checklist items, in the order to be completed, along with associated information, data entry fields for inputting information, and a selectable indicator for indicating whether or not each checklist item has been completed. Various other information and/or selectable buttons may also be provided, either for general use or associated with one or more of the checklist items. For example, some or all of the checklist items may include an audio and/or video button that is selectable to activate audio and/or video recording. Thus, the user may record audio and/or video associated with a particular checklist item, or general audio/video relating to the checklist as a whole or particular portion of the checklist. For example, the user may record audio and/or video during time-out. Suitable icons for indicating recorded and saved audio and/or video may be provided, thus indicating to the user that the audio/video has been saved and indicating to other users that audio/video is available. Text entry fields may also be provided for user-input text notes regarding such checklist items.

Further, speech-to-text functionality, voice-recognition functionality, facial or other visual recognition functionality, and the like may also be provided to integrate audio and/or video features with other information associated with the checklist, for identification purposes, etc. The audio, video, and text files may be saved in any suitable format, e.g., .wav for audio files and .mpg or .mov for video files, depending on user preference, the particular device used, or other factors, and may be emailed, or uploaded to a database, server, system, or other device.

Timestamps, user identification, or other information may be stored and/or displayed with respect to each checklist item. For example, the date, time, and user information regarding completion of the “Correct Patient?” checklist item may be displayed next to this checklist item. Alternatively or additionally, the timestamp information, user identification information, and other information may be stored on the device, emailed, printed, uploaded to a server, database, or system, or may otherwise be recorded or logged (with or without display to the user).

Alerts or other information may also be displayed, stored, logged, or provided, depending on the particular circumstances. For example, an alert in the form of a warning message may be provided next to a particularly important checklist item, a checklist item including information that has or has not been previously confirmed by the patient, a checklist item that has been completed multiple times (consistently or inconsistently), a checklist item that includes incomplete information or information that has been modified, etc. Alerts may also be displayed, stored, logged, or provided that require manual override before permitting the user to proceed, e.g., in the event that a checklist item has not been completed, or to indicate that a particular checklist item or items must be completed prior to proceeding on to the next item or portion of the checklist

FIG. 5 shows a graphical user interface 500 for a checklist application running on a portable electronic device according to embodiments of the present disclosure. The graphical user interface includes fields for acquiring patient data including a patient identification data section 510, a clinical procedure data section 520, and a patient medical data section 530.

The patient identification data section 510 includes a patient name field 512, in which the patient's name is entered, and a patient name verification button 514, which is selected to verify that the patient's name entered into the patient name field 512 is correct. The clinical procedure data section 520 includes a procedure information field 522, in which the name of the procedure to be performed on the patient is entered, and a procedure information verification button 524, which is selected to verify that the name of the procedure entered into the procedure information field 522 is correct. The patient medical data section 530 includes an “Add Allergy” button 532, which is selected to enable a window in which the name of the medicine is input. Once the name of the medicine is input to the window, the name of the medicine is displayed on a button, e.g., button 534. The patient medical data section 530 also includes a patient medical information verification button 536, which is selected by a healthcare provider to verify that the patient medical information shown in the patient medical information buttons, e.g., button 534, are correct.

The checklist application's user interface 500 also includes a unique patient identification field 518 in which to enter data that uniquely identifies that patient. In this embodiment, the unique patient identification field 518 is configured to display an image of the patient and/or an image of a consent form that is captured by the camera 106 of the portable electronic device of FIG. 1 by selecting the capture image button 516. In other embodiments, the unique patient identification field 518 may be configured to display biometric data, e.g., a fingerprint, a unique identifier, etc.

The checklist application's user interface 500 also includes a site marking section 540 in which a site marking verification button 542 is selectable to verify that the correct operative site marking is visible. This is further verified by the operative site image field 546 which displays an image of the operative site marking or other image related to the clinical procedure data that is captured by the camera 106 of the healthcare provider device 100 of FIG. 1 by selecting the capture image button 544. Section 550 of the user interface 500 includes a verification button 552 to verify that prophylactic antibiotics have been administered. Section 560 of the user interface 500 includes a verification button 562 to verify that the Venous Thromboembolism (VTE) prophylaxis has been ordered.

The materials/equipment section 570 of the checklist user interface 500 includes a verification button 572 that is selectable to verify that implants or instruments have been ordered and/or are available for the clinical procedure. The materials/equipment section 570 of the user interface 500 also includes a verification button 574 that is selectable to verify that X-Ray images have been obtained and are available to the healthcare provider. The materials/equipment section 570 further includes a “not applicable” button 576 that is selectable by the healthcare provider for those procedures that do not require X-Ray images. Similarly, if the items identified in sections 550 and 560 are not applicable to the procedure to be performed by a healthcare provider, respective buttons 564 and 576 are selectable to indicate that the respective item is not applicable to the clinical procedure to be performed.

The checklist interface 500 further includes a signature field 580, in which the healthcare provider can electronically write her signature to certify that the patient data and the selection of verification buttons is correct. If, for any reason, the healthcare provider would like to delete a signature in the signature field 580 or rewrite a signature, the checklist interface 500 provides a “clear signature” button 582, which clears the signature field 580.

The certification or “approve” button 588 is selected to approve a completed checklist. When the certification button 588 is selected, an image of the checklist screen 500 is captured and saved locally or exported to another device, such as the healthcare provider server 210. The checklist screen 500 may include buttons that allow the healthcare provider to select the destination of a captured image of the checklist screen 500. The “Save Image” button, for example, may be selected to capture a screenshot of the checklist screen 500 as currently displayed and to save the image, e.g., as a .jpg file or in any other suitable file format, to the healthcare provider device. Timestamp and other metadata information may also be saved along with the captured screenshot. The “Email Image” button 586 may be selected to email the screenshot to a pre-determined address or group of addresses. In addition to or in the alternative to the “Email” button, appropriate buttons may also be provided for uploading the screenshot to a secure server, electronic medical records database (or other database), systems, or other devices for archival or other purposes.

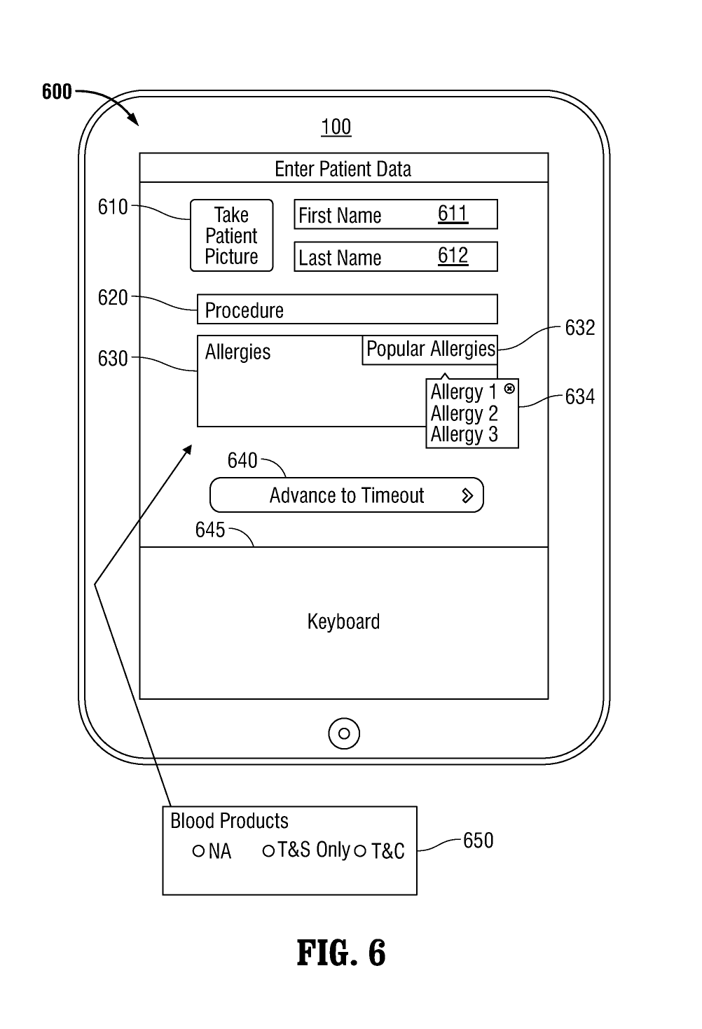

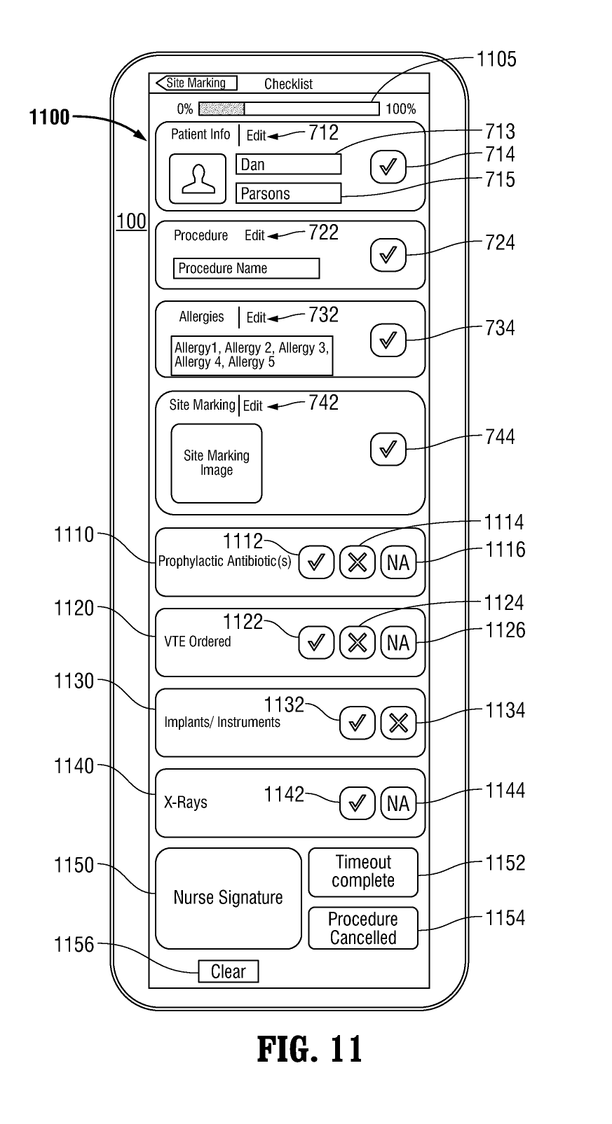

FIG. 6 illustrates a patient data acquisition screen 600 of the checklist application that collects patient data in a data acquisition phase or mode. The patient data collected in the data acquisition phase is used to populate fields of the checklist screen 1100 generated by the checklist software application, as shown in FIG. 11. The data acquisition phase is typically performed a day or more before the clinical procedure is performed when the patient is fully alert. The patient data screen 600 may be completed by a healthcare provider at a location different from the location where the clinical procedure is scheduled to be performed. The patient data screen 600 includes a patient first name field 611, in which the patient's first name is entered by using the keyboard 645, and a patient last name field 612, in which the patient's last name is entered by using the keyboard 645.

When the “Take Patient Picture” button 610 is selected, the camera 106 of the healthcare provider device 100 (as shown in FIG. 1) is enabled so that an image of the patient can be captured. The captured image of the patient may initially be stored locally on the device. The patient data screen 600 also includes a procedure field 620, in which the name of the clinical procedure is entered, and a medical data field 630, in which medical information regarding the patient is entered. As shown in FIG. 6, the medical information is the allergy information of the patient. The medical data field 630 includes a button 632, which, when selected, lists potential medical information, such as the list of allergies 634.

For procedures that are performed in a hospital setting, a blood product file may be required. Thus, the patient data screen 600 may display a blood products section 650 that includes radio buttons for indicating a blood test to be ordered. As shown in FIG. 6, the radio buttons may include a radio button indicating that a blood test is not applicable for the clinical procedure (e.g., a root canal procedure), a radio button indicating that only a type and screen blood test is required, and a radio button indicating that a type and crossmatch test is required.

The patient data screen 600 includes an “Advance to Time-out” button 640 that is selected after all patient data has been entered into the patient data screen 600 to initiate the time-out phase of the checklist application.

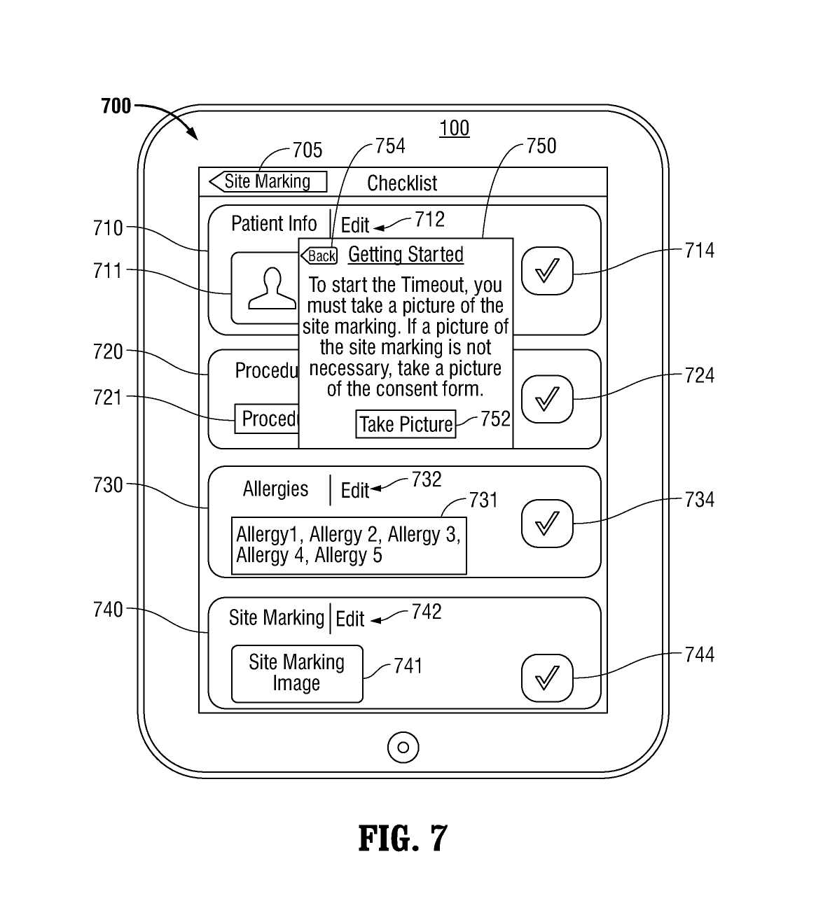

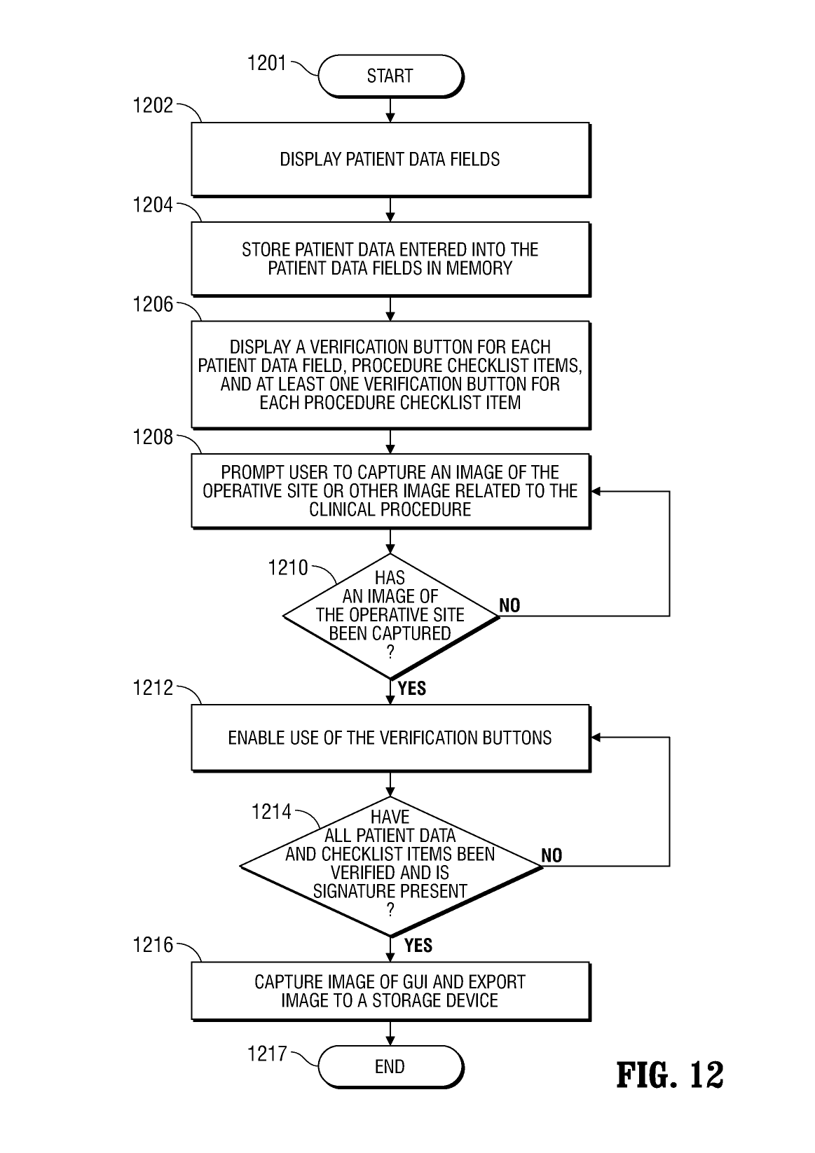

FIG. 7 illustrates a checklist screen 700 having a patient information section 710, a procedure information section 720, and an allergy information section 730, each of which include fields that are populated with the information that is entered into the patient data screen 600 of FIG. 6. Specifically, the patient information section 710 includes an image field 711, which is populated with the image captured by selecting the capture image button 616 of FIG. 6, a first name field 713 (see FIG. 12), which is populated with the data entered into the patient first name field 611 of FIG. 6, and a last name field 715 (see FIG. 12), which is populated with the data entered into the patient last name field 612 of FIG. 6. Similarly, the procedure information section 720 includes a procedure field 721, which is populated with the procedure data entered into the procedure field 620, and the allergy information section 730 includes an allergy information field 731, which is populated with the allergy data entered into the medical data field 630 of FIG. 6.

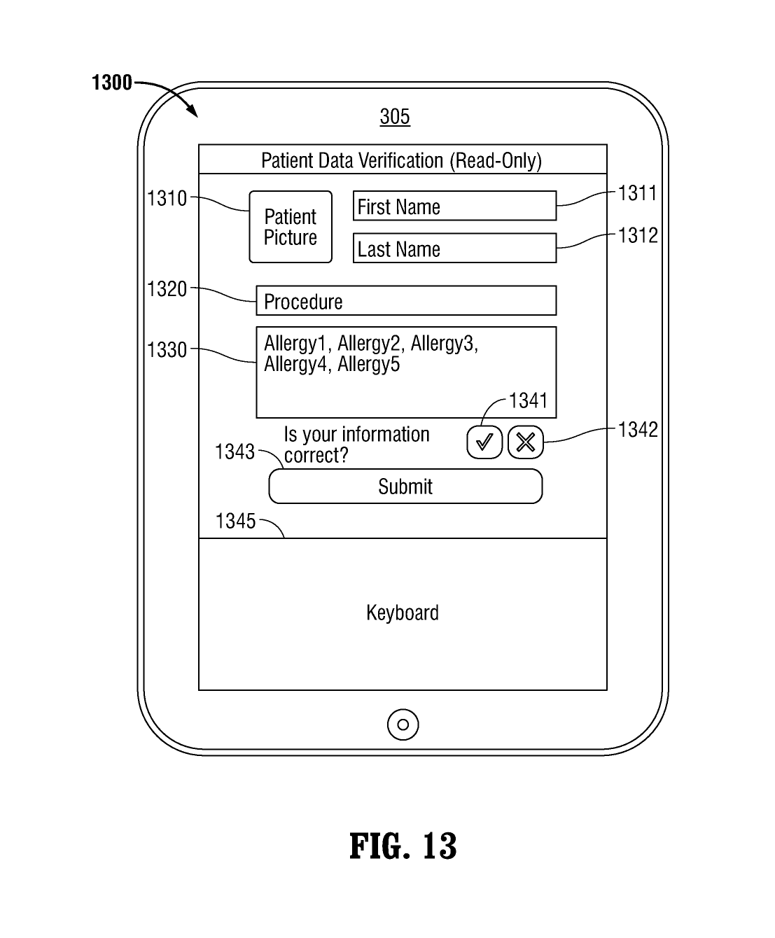

In some embodiments, the data entered in the patient data screen 600 may be presented to the patient via a patient data verification software application, which is described in more detail below with respect to FIG. 13. The patient data verification software application may run on the patient device 305 of FIG. 3, such as a tablet, smartphone, or other portable electronic device, or on a website accessible by the patient so that the patient can verify the accuracy of the patient data.

After the “Advance to Time-out” button is selected in FIG. 6, the data entered into the patient data screen 600 and stored in a local or remote database is loaded into the appropriate fields of the check list screen 700. At the same time, a start window 750 is displayed in front of the check list screen 700 prompting the user to take a picture of the site marking or a consent form to start execution of a time-out procedure. The start window 750 includes a “Back” button 754 that causes the healthcare provider device 100 to redisplay the patient data entry screen 600.

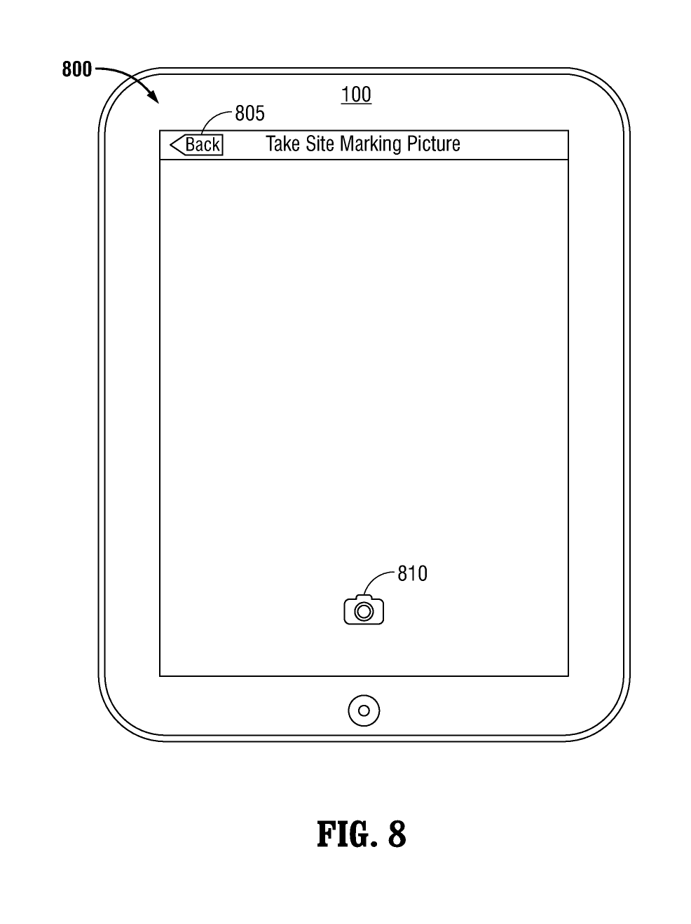

Until the user takes a picture of the site marking or consent form, the checklist application does not start execution of the time-out checklist. In the embodiment illustrated in FIGS. 8-10, the checklist application does not start execution of the time-out checklist until the site marking is captured, reviewed, and approved for use by the healthcare provider. In some embodiments, the verification buttons are not enabled until the user takes a picture of the site marking or the consent form. These features prevent any attempt by the healthcare provider to improperly pre-populate the checklist screen 1100 of FIG. 11.

FIG. 8 illustrates a site marking image capturing screen 800 that is displayed once the “Take Picture” button 752 is selected in FIG. 7. The site marking image capturing screen 800 displays what is seen through the lens of the portable electronic device so that the user can direct the camera toward the site marking. The user may then capture an image of the site marking by selecting the camera icon 810. Additionally or alternatively, the site marking image capturing screen 800 may include an icon, which, when selected by the user, causes the camera to capture a video of the site marking. If the user would like to return to the screen 700 of FIG. 7, the user may select the “Back” button 805.

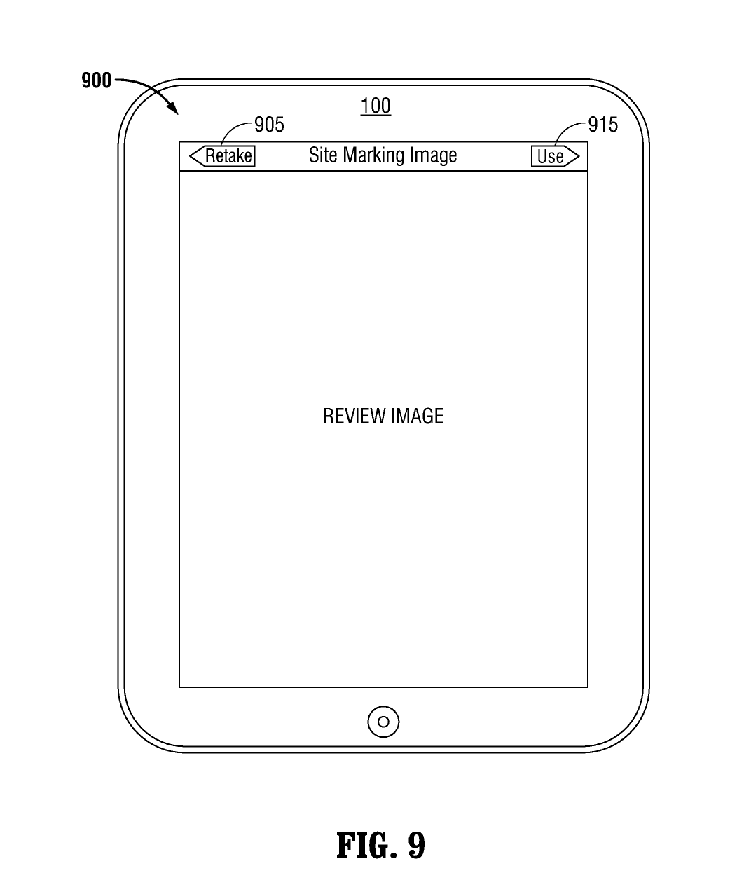

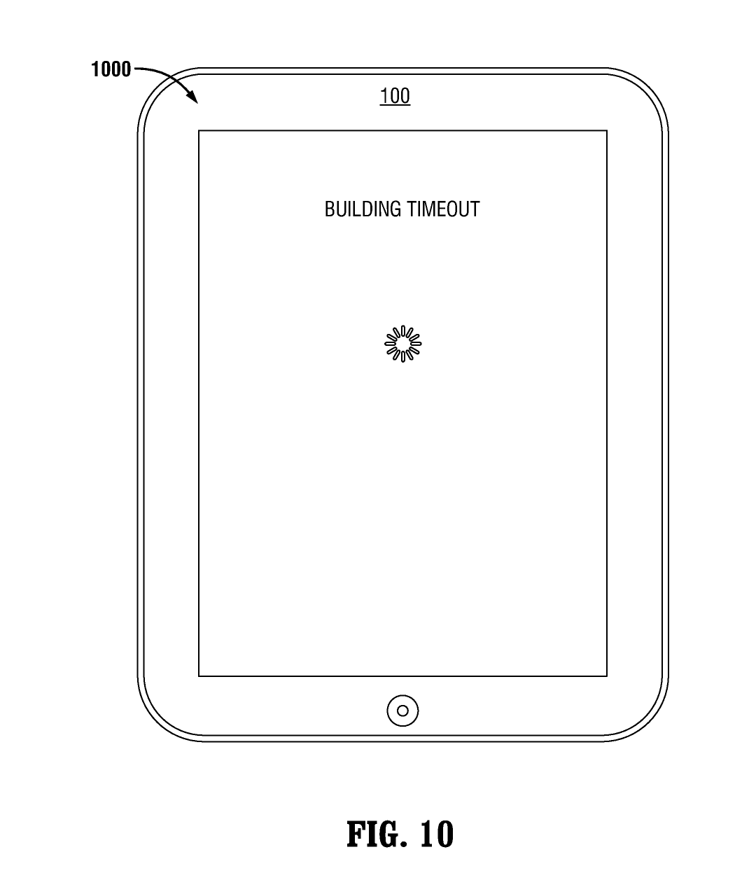

After the image of the site marking is captured, the image is displayed in an image reviewing screen 900 of FIG. 9 to allow the user to review the image. If the user would like to retake a picture of the site marking, the user can select the “Retake” button 905 to return to the site marking image capturing screen 800 of FIG. 8. Otherwise, the user can select the “Use” button 915 to use the captured image and to build a checklist so that execution of checklist can be initiated. While the checklist is being built, screen 1000 of FIG. 10 may be displayed to signal to the user that the checklist is being built.

Once the checklist is built, the healthcare provider device 100 displays the checklist screen 1100 of the checklist application as shown in FIG. 11. Once the checklist is built, the checklist application may also enable all buttons and selectable items in the checklist screen 1100 and may also start capture of audio and/or video. Once execution of checklist is started, the healthcare provider cannot exit the checklist until the checklist is completed or the checklist is completed and signed. This feature and the capture of audio and/or video of the execution of the checklist also prevents any attempt by a healthcare provider to improperly pre-populate the checklist. The checklist screen 1100 includes a “Site Marking” button 705 which, when selected, causes the healthcare provider device 100 to redisplay the site marking image capturing screen 800 of FIG. 8. This allows the healthcare provider to retake an image of the site marking in case the image displayed in the site marking image field 741 needs to be changed.

As with the checklist screen 500 of FIG. 5, the checklist screen 1100 includes sections 1110, 1120, 1130, and 1140 that identify items that must be verified before the clinical procedure is performed. Each of the sections 1110, 1120, 1130, and 1140 may include multiple buttons for confirming (e.g., buttons 1112, 1122, 1132, and 1142) or denying (e.g., buttons 1114, 1124, and 1134) the presence of each item, or for marking as inapplicable (e.g., 1116, 1126, and 1144) each item.

The checklist screen 1100 also includes a percentage completion bar 1105, indicating both graphically and numerically, the current completion percentage of the checklist or particular portion thereof. As an alternative to or in conjunction with the percentage completion bar 1105, any other suitable graphical indication of the progress of the checklist may be utilized.

The healthcare provider can edit patient data by selecting the “Edit” buttons 712, 722, 732, and 742. The healthcare provider approves the patient data by selecting the verification buttons 714, 724, 734, and 744, which may be highlighted when selected to sufficiently distinguish it from unselected verification buttons.

The checklist screen 1100 also includes a signature field 1150, in which a healthcare provider, e.g., a nurse, can electronically write her signature to certify that the patient data and the selection of verification buttons is correct. If, for any reason, a healthcare provider would like to delete a signature in the signature field 1150 or rewrite a signature, the checklist screen 1100 provides a “Clear” button 1156, which clears the signature field 1150.

When time-out checklist is complete, the healthcare provider selects the “Timeout Complete” button 1152, which causes the healthcare provider device 100 to capture an image of the checklist screen 500 and/or save the checklist data to the healthcare provider server 210. The checklist application then returns to the patient data entry screen 600 in preparation for next patient or procedure. If the procedure is cancelled or delayed for any reason, the checklist screen 1100 further includes a “Procedure Cancelled” button 1154, which causes the HCP device 100 to securely save the current data to the HCP server 210, but flags the data as a cancelled procedure.

In case the healthcare provider device is unable to sync the patient data and the checklist execution data with a remote storage device, the portable electronic device can store the patient data and the checklist execution data locally until the portable electronic device is able to sync with the remote storage device. Also, in the case where the portable electronic device running the checklist application is used in a location where wired and wireless services may not be available, the patient data and the checklist execution data is encrypted and saved locally on the HCP device until it later synchronizes with remote servers, etc. In some embodiments, a completed checklist or one produced when a procedure is canceled is locked in a read-only state so that it cannot be altered either locally or remotely.

FIG. 12 is a flow diagram of a method performed by the checklist application for verifying patient data for a clinical procedure according to aspects of the present disclosure. After starting in step 1201, patient data fields are displayed in step 1202 via a graphical user interface. The patient data fields include a patient name data field, a patient identification data field, a patient medical data field, and a clinical procedure data field. In step 1204, patient data entered into the patient data fields is stored in memory, e.g., the memory 104 of the HCP device 100. In step 1206, a verification button corresponding to each of the patient data fields, procedure checklist items to be verified before execution of the clinical procedure, and at least one verification button corresponding to each of the procedure checklist items are displayed, via the graphical user interface, e.g., the checklist screen 700 of FIG. 7.

In step 1208, a user, i.e., a healthcare provider, is prompted to capture an image of the operative site or other image related to the clinical procedure. For example, as shown in FIG. 7, the user of the healthcare provider device 100 may be prompted by the message in the start window 750 that overlays the checklist screen 700. In step 1210, it is determined whether an image of the operative site has been captured. If it is determined that the image of the operative site has been captured, use of the verification buttons is enabled in step 1212. Otherwise, the user will continue to be prompted to capture an image in step 1208. In step 1214, it is determined whether all patient data and checklist items have been verified and a signature is present in a signature field. If so, an image of the checklist graphical user interface is captured and the image is exported to a storage device in step 1216, and then the process of FIG. 12 ends in step 1217. For example, the image of the checklist graphical user interface may be exported to the healthcare provider (HCP) server 210 shown in FIGS. 2-4. Otherwise, the checklist application returns to step 1214.

The systems and methods according to the present disclosure bridge the gap between a patient's initial contact with the healthcare provider and execution of a procedure performed by the healthcare provider. This is accomplished by enabling the patient to certify that the patient data gathered by the healthcare provider during the acquisition phase of the checklist application is correct.

FIG. 13 is a diagram of a patient's device, e.g., the patient device 305 of FIGS. 3 and 4, displaying a patient data verification screen 1300 according to an aspect of the present disclosure. In some embodiments, the patient may be given the opportunity via the patient data verification screen 1300 to review patient data that has been entered into the checklist application during the data acquisition phase. The patient data verification screen 1300 includes data fields that are loaded with data entered into the patient data entry screen 600 of FIG. 6 by a healthcare provider prior to the display of the patient data verification screen.

The data fields include a patient picture field 1310 for displaying an image of the patient, a first name data field 1311, a last name data field 1312, a procedure data field 1320, and an allergy data field 1330. These data fields are read-only so that the patient cannot edit the patient data using the keyboard 1345 in order to maintain the integrity of the patient data. The patient data verification screen 1300 includes an approve button 1341 that the patient can select to approve the displayed patient data and a reject button 1342 that the patient can alternatively select to reject the displayed patient data if there is an error in the patient data. The patient may send the verification information to the healthcare provider device 100 or the healthcare provider server 210 by selecting the “Submit” button 1343. If the reject button 1342 is selected, the checklist application may display an error message to the healthcare provider requesting that the healthcare provider correct the patient data.

In embodiments, the patient data verification screen 1300 may be displayed on the healthcare provider's device 100 so that the healthcare provider can give the healthcare provider's device 100 to the patient to approve or reject her patient data.

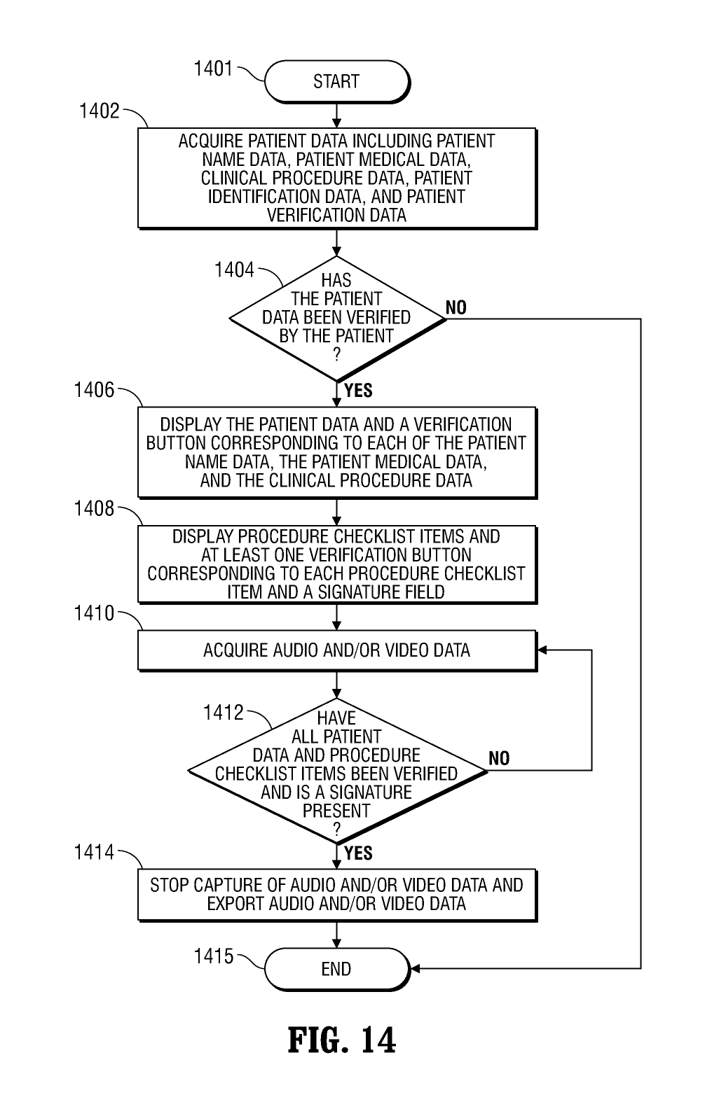

FIG. 14 is a flow diagram of a method for verifying patient data for a clinical procedure according to other aspects of the present disclosure. After starting in step 1401, patient data is acquired from a healthcare provider database in step 1402. The patient data includes patient identification data, patient medical data, clinical procedure data, data that uniquely identifies the patient corresponding to the patient data, and patient verification data. The patient identification data is data that uniquely identifies the patient. The patient identification data may be biometric data, a unique identifier, a photographic image, or a combination of these types of identification data. In step 1404, it is determined whether the patient data has been verified by the patient based on the patient verification data.

If the patient data has not been verified by the patient, the process of FIG. 14 ends in step 1415. Otherwise, the patient data and a verification button corresponding to each of the patient identification data, the patient medical data, and the procedure data are display in step 1406 via a graphical user interface. Also, in step 1408, at least one verification button corresponding to each item of information to be verified for the clinical procedure and a signature field are displayed. Then, in step 1410, audio and/or video of execution of the time-out procedure is captured. The audio and/or video data may be acquired from a camera that can capture operating room area.

In step 1412, it is determined whether verification buttons for each item has been selected and a signature is present. If not all of the verification buttons have been selected, the process continues to capture audio and/or video data in step 1410. Otherwise, the capturing of audio and/or video data is stopped and the audio and/or video data is saved locally or remotely in step 1414, and the process ends in step 1415.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto. For example, the HCP device 100 of FIG. 1 may be a non-portable device such as a desktop computer that is in wired or wireless communication with a separate camera.

What is claimed is:

1. A method for verifying information for a procedure performed by a healthcare provider, comprising:
acquiring, in an acquisition mode, patient data including patient name data, patient medical data, procedure data, and patient identification data;
acquiring, in the acquisition mode, patient verification data in which the patient has verified the correctness of the patient data prior to execution of a procedure;
displaying, in an execution mode, the patient data and at least a first verification button corresponding to the patient data;
displaying, in the execution mode, procedure checklist items and at least a second verification button corresponding to procedure checklist items to be verified before execution of the procedure and a certification field; and
acquiring, in the execution mode, audio and/or video data until the at least the first verification button and the at least the second verification button have been selected and certification data has been entered into the certification field.

2. The method according to claim 1, wherein the patient identification data is selected from the group consisting of biometric data, a unique identifier, and a photographic image.

3. The method according to claim 1, wherein acquiring patient data includes acquiring patient data from a healthcare provider server and populating patient data fields in a graphical user interface corresponding to the patient identification data, the patient medical data, and the procedure data.

4. The method according to claim 3, further comprising determining whether the patient data has been verified by the patient based on the patient verification data; and
displaying the patient data and at least one verification button corresponding to the patient data if it is determined that the patient data has been verified by the patient.

5. The method according to claim 3, further comprising:
transmitting the patient data to another computing device which displays the patient data and generates the patient verification data; and
receiving the patient verification data from the another computing device.

6. The method according to claim 3, further comprising:
starting a timer when the patient verification data is generated;
determining whether the time of the timer is greater than a predetermined time value; and
deleting the patient verification data if it is determined that the time of the timer is greater than the predetermined time value.

7. The method according to claim 3, wherein the acquisition mode and the execution mode are enabled based on the timing provided by a scheduling application.

8. The method according to claim 1, further comprising:
displaying, in a first screen, data fields corresponding to the patient name data, the patient medical data, the procedure data, and the patient identification data;
storing data entered into the data fields of the first screen in a database;
displaying, in a second screen, which is read-only, the patient name data, the patient medical data, the procedure data, and the patient identification data;
displaying, in the second screen, a patient verification button, which, when selected by the patient, generates the patient verification data; and
storing the patient verification data in the database.

9. The method according to claim 1, wherein the verification buttons are not enabled until an image of a procedure site or a consent form is captured.

10. The method according to claim 9, further comprising displaying a message prompting a user to capture an image of the procedure site to enable the verification buttons.

11. The method according to claim 1, further comprising:
capturing an image of a graphical user interface when the certification data has been entered into the certification field; and
saving the captured image to a local or remote database or transmitting the captured image to another computing device.

12. The method according to claim 1, further comprising:
displaying an edit button enabling a user to edit the patient data; and
displaying a time stamp near the patient data that is edited by the user.

13. The method according to claim 1, further comprising displaying a progress bar that increases in size as verification buttons are selected and certification information is entered into the certification field.

14. The method according to claim 1, wherein the items that must be verified before carrying out the procedure are selected from the group consisting of whether the patient position is correct, whether the side/site marking is visible, whether a medication has been administered to the patient, whether lab tests have been ordered, whether instruments for the procedure are present, whether implants are present, whether X-rays are present, or any combination of these items.

15. A method of verifying information for a clinical procedure, comprising:
displaying, via a graphical user interface, patient data fields including a patient name data field, a patient identification data field, a patient medical data field, and a clinical procedure data field;
storing patient data entered into the patient data fields in memory;
displaying, via the graphical user interface, a verification button corresponding to each of the patient data fields, procedure checklist items to be verified before execution of the clinical procedure, and at least one verification button corresponding to each of the procedure checklist items;
prompting a user to capture an image of an operative site or another image related to the clinical procedure;
determining whether an image of the operative site has been captured;
enabling use of the verification buttons if it is determined that an image of the operative site has been captured;
determining whether a verification button for each of the patient data fields and the procedure checklist items has been selected and signature data has been entered into a signature field; and
capturing an image of the graphical user interface if it is determined that a verification button for each of the patient data fields and the procedure checklist items has been selected and signature data has been entered into a signature field.

16. The method according to claim 15, wherein acquiring an image of the patient includes displaying a button, which, when depressed, enables the user to search for and select an image stored in a local or remote database or to capture an image of the patient using an imaging device in communication with the graphical user interface.

17. The method according to claim 15, wherein the verification buttons are maintained in a non-functional state until an image of the operative site is captured.

18. A system for verifying patient data for a clinical procedure, comprising:
a healthcare provider server configured to store patient data and to transmit the patient data to a patient device for verification by a patient;
a healthcare provider device in communication with the healthcare provider server, the healthcare provider device comprising a processor and a memory storing instructions that, when executed by the processor, causes the healthcare provider device to:
display a patient data acquisition screen having patient data fields in which to input patient data;
transmit the patient data entered into the patient data fields of the patient data acquisition screen to the healthcare provider server;
receive patient verification data from the patient device;
display a checklist execution screen including patient data fields populated with the patient data, a verification button corresponding to each of the patient data fields, descriptions of items to be verified for the clinical procedure, at least one verification button corresponding to each of the items to be verified for the clinical procedure, and a certification button for approving a completed checklist;
capture an image of a procedure site or another image related to the clinical procedure; and
capture an image of the checklist execution screen when the certification button is selected.

19. The system according to claim 18, wherein the checklist execution screen is displayed if it is determined, based on the patient verification data, that the patient approves of the patient data entered into the patient data fields of the patient data acquisition screen.

20. The system according to claim 18, wherein the patient data includes patient name data, patient medical data, clinical procedure data, and patient identification data.

21. The system according to claim 18, wherein the instructions further cause the healthcare provider device to acquire audio and/or video data while the checklist execution screen is being displayed.

22. The system according to claim 18, wherein the verification buttons and the certification button are not enabled for use until after an image of the procedure site or other image related to the clinical procedure is captured.
